(19) United States
(12) Patent Application Publication
(10) Pub. No.: US 2012/0109750 A1
(43) Pub. Date: May 3, 2012

(54) METHOD FOR REDUCING UNWANTED PAPER ADVERTISEMENTS IN COMMERCE

(76) Inventor: Francoise Becquey-Weisenburger, Stow, OH (US)

(21) Appl. No.: 13/283,014

(22) Filed: Oct. 27, 2011

Related U.S. Application Data
(60) Provisional application No. 61/407,144, filed on Oct. 27, 2010.

(51) Int. Cl. G06Q 30/02

(52) U.S. Cl. 705/14.54; 705/14.73

(57) ABSTRACT

A method for reducing unwanted paper advertisement mailings includes offering an interface for presenting advertisements from businesses for products or services to consumers, presenting the advertisement to the consumers, and providing the consumers with information for opting out of paper advertisement mailings from the businesses.

This application claims priority of U.S. Provisional Patent Application No. 61/407,144, filed on Oct. 27, 2010, which is incorporated herein by reference.

### TECHNICAL FIELD

The invention is generally related to commerce and methods for reducing junk mail, shopping for products or services, and receiving advertising materials.

### BACKGROUND

Paper advertising materials are commonly distributed to a much larger audience than what is interested in the products or services being promoted. Such paper advertising materials may arrive through the mail services, and therefore are sometimes referred to as “junk mail.” Moreover, some forms of junk mail can present a much larger range of products or services than the one, two, or several that a consumer might be interested in shopping for or purchasing. Thus, junk mail is generally regarded as being over distributed and over inclusive in the products and services it promotes. This leads to wasting resources. For example, junk mail leads to substantial wastes of paper, ink, and production and delivery resources.

Those who are concerned with resource consumption may find junk mail undesirable, even to the point of preferring not to receive it. Others may be concerned with resource consumption, but appreciate learning about the various promotions that the advertising materials contain.

Computer-based shopping and shopping research are presently popular. Consumers use their computers, telephones, and other devices to purchase products or services and to research the products or services that interest them. The products or services may be purchased at a local retail establishment, or from a distant business. Notwithstanding the popularity of computer-based shopping and shopping research, substantial amounts of junk mail are still prepared and distributed.

Thus, a need exists in the area of commerce for ways to reduce junk mail, while still having access to information about products or services, including advertising materials.

### SUMMARY

The present invention provides a way for businesses to present advertisements for products and services to interested consumers in a way that may reduce the use of paper advertising materials. In particular, a commerce interface, such as a webpage, can provide targeted advertisements in response to a consumer's searches and can provide information to the consumer for opting out of paper advertisement mailings, including those from businesses whose advertisements appear on the website. By directly reaching some of its target customers through the website, a business may choose to purchase and mail fewer paper advertisement materials. And, consumers may be provided with information for opting out of paper advertisement mailings, which may reduce the number that are printed and delivered. Together, the demand for paper advertising materials may be reduced.

According to an embodiment of the invention, a method for reducing unwanted paper advertisement mailings includes offering an interface for presenting advertisements from businesses for products or services to consumers, presenting the advertisement to the consumers, and providing the consumers with information for opting out of paper advertisement mailings from the businesses.

### BRIEF DESCRIPTION OF THE DRAWINGS

FIG. 1 is a schematic representation depicting features of a website that may reduce the demand for paper advertising materials.

### DETAILED DESCRIPTION

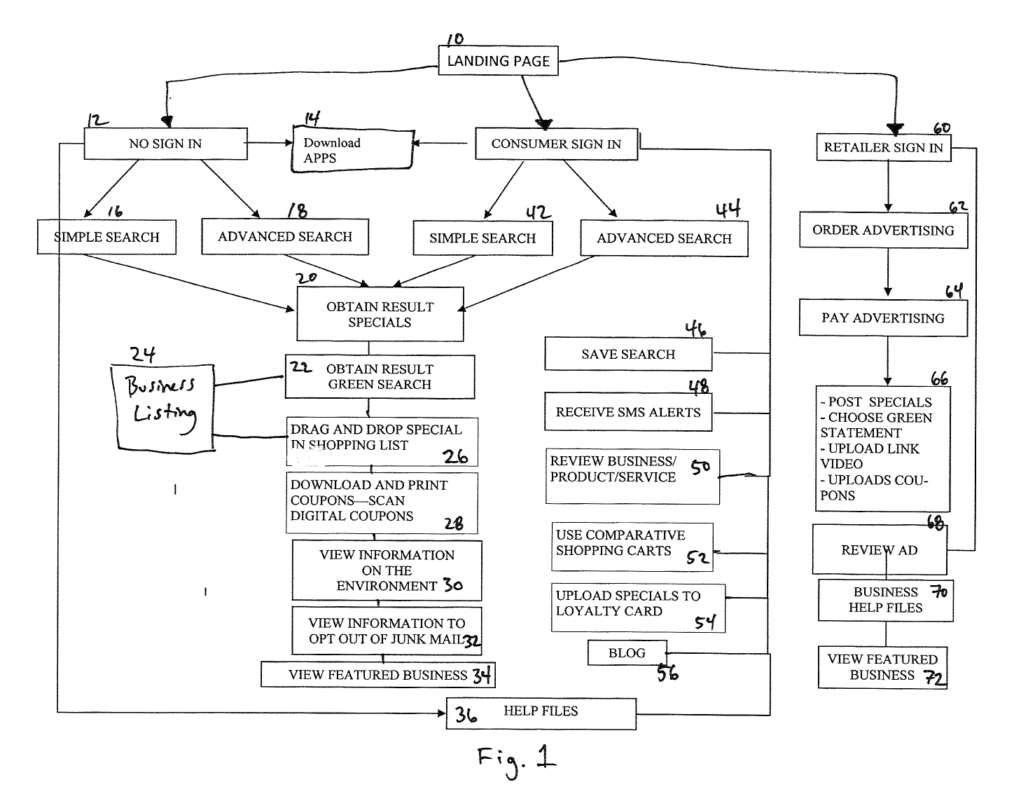

Referring to FIG. 1, examplary features for engaging in commerce such as through a website or other similar commerce interface are shown. The features include options that may be used to replace or reduce distributed printed advertising materials, including those for regionally local businesses that provide products or services. The arrangement of the features in the figure does not generally indicate an order or a sequence, unless an order or sequence is specifically identified herein.

FIG. 1 shows a landing page 10 of a website or other similar commerce interface. Landing page 10 may be designed to promote the use of the website as an advertising media for businesses, including local businesses. Landing page 10 may cater to three different kinds of users, including, for example: (1) businesses that provide products or services and wish to use the landing page 10, (2) casual consumers who visit the landing page 10, and (3) consumers registered with the landing page 10. Consumers, whether casual or registered, may access the landing page 10 through a web browser or similar tool and may carry out searches. Casual consumers have the option to use the landing page 10 anonymously, without registering with the landing page 10 or otherwise signing in.

For example, and referring to feature 12, a casual consumer may enter the website through the landing page 10 without the need for registering or logging in. Feature 14 provides a consumer with applications or other downloadable features, which may be offered free of charge to the consumer. Features 16 and 18 provide a simple or an advanced search feature that may be conducted for products or services. Using the simple search of feature 12, the consumer may use single or multiple search criteria, such as, for example, keywords, brand names, categories, seasonal offerings, UPC codes, store names, mall names, city names, neighborhood names, street intersections, zip codes, and the like. Similar search features are possible through the advanced search feature 14. Feature 20 provides the presentation of search results responsive to the search information entered through features 16, 18, and the search results may be presented as a list of advertisements for products or services, tags on a map identifying businesses associated with particular products or services, or as a list of products, services, or businesses. The presentation of search results may relate to the relevance of an advertisement to the product or service searched, the geographic location of a business selling products or services, and other relevant factors. Through an appropriate interface, the search results may include various information, such as business promotions or specials. The interface can also provide business or store specific information.

The search results may include information from, or pertain only to, businesses that have chosen to participate with the website. These businesses are referred to herein as “participating businesses.”

At feature 22, a consumer has the option of limiting the search results obtained through the feature 20 to those from participating businesses who are associated with so-called green products or services. As used herein, green products or services include those products or services that a participating business has identified as being green products or services. Generally, green products or services are understood to include those products or services that reflect a concern for resource consumption, or come from sources having a concern for resource consumption. Non-limiting examples of green products or services include those that are manufactured or sold according to methods that minimize resource wastes or adverse impacts to the Earth's environment.

At feature 24, a consumer may obtain information about the participating businesses, including those whose products or services appeared in the search results of the features 20 or 22. This information can include, for example, the general nature of a participating business, a link to a participating business's website, a participating business's retail location address, telephone number or email address, or the like.

At feature 26, a consumer may add one or more of the products or services identified in the search results to a shopping list. The shopping list may be used to temporarily collect various products or services that interest the consumer in a list for later reference.

At feature 28, a consumer may retrieve and save or print coupons for products or services offered by the participating businesses, whether the coupon is issued by the participating businesses or another source of the products or services.

At feature 30, a consumer may view information relating to the Earth's environment, resource consumption information, or other related information provided by the operators of the website.

At feature 32, a consumer may view information relating to opting out of printed advertisement mailings, including the printed advertisement mailings of the participating businesses.

At feature 34, a consumer may view information relating to one or more featured participating businesses, the featured participating businesses being chosen by the operators of the website. The operator of the website may choose to feature a business, for example, based on the business's initiatives relating to green products or services.

At feature 36, a consumer may access help files or information related to using the landing page 10 or any of its associated features, including those disclosed herein.

At feature 40, consumers registered with the landing page 10 may log in. Registered consumers may also access the download options of feature 14. Features 42 and 44 provide simple and advanced search features for a registered consumer like those provided at 16, 18 for an unregistered user. A registered user may also use any of the features 20, 22, 24, 26, 28, 30, 32, 34, and 36 described above.

In addition, at feature 46, a registered consumer may save any of the searches conducted through features 42, 44.

At feature 48, a registered consumer may elect to receive short message service (SMS) messages relating to any product or service identified in the search results, or any other product or service available through the participating businesses.

At feature 50, a registered consumer may submit opinions regarding a participating business or any product or service, such as in the form of a consumer review. Registered consumers can also view their own reviews and those submitted by others.

At feature 52, a registered consumer may view comparative shopping list information that provides comparisons between plural products or services in the registered consumer's shopping list, such as may be useful for comparing prices or other qualities.

At feature 54, a registered consumer may access information relating to a participating business's loyalty program, such as a loyalty card program, and associate any of a participating business's promotional specials with the registered consumer's loyalty card.

At feature 56, a registered consumer may publish information on a web log, or blog.

Features are also provided from the landing page 10 of the website for allowing a business to become associated with the website to become a participating business, and for a participating business to control the information and advertisements presented to consumers through the website.

At feature 60, a business or retailer may sign up to become a participating business. Again, the search results obtained by consumers through the search features 16, 18, 42, and 44 only relate to participating businesses, so a business must sign up to become a participating business. A business may provide information, such as, for example, specific information about the business, its location, the products or services it sells, retail store hours, and the like. After signing up, a participating business is issued credentials, such as a login name and password, and may log into the website.

At feature 62, a participating business may choose options for advertising its products or services, such as the type, features, or number of products or services offered for sale, the duration of the advertisement period, and the like. In some embodiments, the website may only allow a participating business's advertisements to be presented to consumers searching from a particular geographic area, such as the general geographic location of the participating business. Thus, for example, a consumer searching for products or services in only Kent, Ohio may be presented with advertisements only from businesses in Kent, Ohio.

At feature 64, a participating business may make payment arrangements for its advertising. In some embodiments, the payment may be received and processed through the website. After payment is successfully processed, advertisement templates, forms, or other input options are presented to the participating business in order to allowing it to compose the advertisements.

At feature 66, a participating business that has paid for advertising is presented with several options for promoting its business, including being able to post advertisements or promotional specials. In addition, the participating business may also choose whether to be associated with a green statement pertaining to green products or services issues, such as, for example, “We support [the operator of the landing page 10] as our green initiative of choice”; “We support Treezoid as our green initiative of choice”; “We help plant trees through the Arbor Day Foundation”; “We support the preservation of forests for our children's sake”; “We help save trees by reducing flyer distribution”; “We contribute to the protection of the environment by reducing paper waste”; and other related green statements. The participating business may also provide links, videos, links to videos, coupons, links to information, and other relevant product or service information for access by consumers. Also, the participating business may identify which of its products or services, if any, qualify as green products or services, as discussed above. The participating business may also identify any other information relevant to its products or services, including, for example, whether its products or services are seasonal products, whether the products have been advertised on television, and so on.

At feature 68, a participating business that has paid for advertising may save its advertisements and review them before they are available for viewing by consumers. The participating business may also post its advertising so that it may be viewed by consumers.

At feature 70, participating businesses, including those that have paid for advertising and those that have not, may access help files or information related to using the landing page 10 or any of its associated features, or for conducting business through the website.

At feature 72, a participating business may view information relating to one or more featured participating businesses, the featured participating businesses being chosen by the operators of the website, as discussed above.

Through the features disclosed herein, a business may choose to participate in commerce in way that can reduce junk mail while still communicating information about and advertisements for products and services to interested consumers. In particular, targeted advertisements presented directly to interested customers should reduce the quantity of printed advertising materials that a business is interested in purchasing and distributing. And, consumers may participate in commerce in a way that reduces the need for paper advertising materials by searching for information and shopping with businesses that use the features disclosed herein. In particular, a consumer may seek information about, and advertisements for, products or services without using paper advertising materials. And, a consumer can search for the particular products or services that interest him or her. Moreover, consumers may be provided with information for opting out of paper advertisement mailings. Taken together, fewer paper advertising materials may be created and distributed, leading to a reduction in the total amount of junk mail.

The features disclosed herein may be combined in methods of commerce in any manner or order.

Although the examples given include many specificities, they are intended as illustrative of only one possible embodiment of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

What is claimed is:

1. A method for reducing unwanted paper advertisement mailings, comprising:
offering an interface for presenting advertisements from businesses for products or services to consumers,
presenting the advertisement to the consumers, and
providing the consumers with information for opting out of paper advertisement mailings from the businesses.

2. The method of claim 1, wherein the interface is a webpage.

3. The method of claim 2, further comprising providing search features for the consumers to search for products or services.

4. The method of claim 3, further comprising providing search results in response to a search.

5. The method of claim 4, further comprising limiting the search results to advertisements from businesses associated with green products or services.

6. The method of claim 4, further comprising providing coupons from the businesses to the consumers.

7. The method of claim 4, further comprising presenting information relating to the Earth's environment or resource consumption information.

8. The method of claim 4, further comprising receiving a video for presentation with the advertisement.

9. The method of claim 4, further comprising receiving a link to a video for presentation with the advertisement.

10. The method claim 4, further comprising presenting a green statement with the advertisement.
